(19) United States
(12) Patent Application Publication
(10) Pub. No.: US 2024/0392502 A1
(43) Pub. Date: Nov. 28, 2024

(54) METHOD AND APPARATUS FOR PRODUCING A MOULDABLE CELLULOSIC FIBROUS MATERIAL

(71) Applicant: Papyrus Australia Limited, Mile End (AU)

(72) Inventor: Ramy Abraham AZER, North Adelaide (AU)

(21) Appl. No.: 18/693,405

(22) PCT Filed: Sep. 19, 2022
(86) PCT No.: PCT/AU2022/051127

§ 371 Date: Mar. 19, 2024

(30) Foreign Application Priority Data
Sep. 20, 2021 (AU) 2021903020

(51) Int. Cl. D21D 1/30; D21C 9/18; D21D 5/06; D21H 11/12

(52) U.S. Cl. CPC D21D 1/303; D21C 9/18; D21D 5/06; D21H 11/12

(57) ABSTRACT

The invention relates to a method for producing a mouldable cellulosic fibrous material from a cellulose fibre feedstock, the feedstock having a moisture content greater than about 95% (w/w). The method includes the mechanical pre-treatment of the feedstock to form a fibre furnish, the fibre furnish having fibres with a fibre length distribution such that at least 95% of the fibres have a length less than about 15 mm. The method optionally includes refining the fibre furnish in a high consistency disc refiner before dewatering. The method also includes dewatering the fibre furnish without chemical addition, to produce a cellulose fibre cake and a filtrate, the cellulose fibre cake having a moisture content less than about 40% (w/w). The method finally includes refining the cellulose fibre cake in at least one disc refiner to produce the mouldable cellulosic fibrous material.

### RELATED APPLICATION

This application claims convention priority from Australian provisional patent application 2021903020 filed on 20 Sep. 2021, the content of which is incorporated herein by reference

### FIELD OF THE INVENTION

The present invention relates generally to the production of a cellulosic fibrous material suitable for use in, for example, vacuum moulding to form packaging items such as food and plant service and supply trays and containers, and protective and positioning packaging for the transport or display of medical, electronic or hardware items, amongst many other types of moulded packaging items.

### BACKGROUND OF THE INVENTION

The following discussion of the background to the invention is included to explain the context of the invention. This is not to be taken as an admission that any of the material referred to was published, known, or part of the common general knowledge (in any country) as at the priority date of any of the claims. Furthermore, much of the following description is provided in the context of vacuum moulding being the end use of the mouldable fibrous material produced by the present invention. However, this is done for ease of description and is not to be regarded as limiting in relation to final uses for the material.

Herbaceous plants have been relied upon as a feedstock for paper for thousands of years. However, for at least the last century, wood has become the primary fibre source for paper feedstock, and pulping has become by far the major fibre processing technique. Indeed, the demand for pulp over that period of time has given rise to several of the world's more prominent and controversial environmental and ecological issues.

It is accepted that the conversion of wood into paper requires the use of heavy-duty industrial processes, typically requiring very large energy inputs, high volumes of process water, and having high waste levels, and generally using chemicals that give rise to difficult and sometimes hazardous disposal and recycling requirements. Also, the pulping process, be it chemical or mechanical, is often unable to adequately control the condition and geometry of fibres in the furnish produced, at least to the extent that downstream papermaking processes regard as desirable.

Thus, there has been a growing interest in developing alternative fibre crops for use in the production of paper products, and alternative technologies to replace pulping. One source of cellulosic fibre that has been recognised as a suitable alternative to wood is the banana plant.

The banana plant is a large perennial herb with tall aerial shoots that arise from swollen, fleshy corms (an underground rhizome). The banana plant's petioles are arranged spirally in the aerial shoots, and their long overlapping pulvini (basal enlargements) form the outer portion of a stout, trunk-like pseudostem, through the centre of which the terminal inflorescence grows, forming an inner portion often referred to as a core. Higher up, the petioles bend away from the pseudostem and bear large oval blades (leaves) at an oblique angle. When mature, each pseudostem will thus comprise a soft but dense core, surrounded by an outer portion that is tougher but is less dense.

Commercially planted banana plants typically only have 1 to 2 year life-spans, as banana plants only flower (and produce bananas) once, following which the leaves and pseudostem start to die. This usually requires their removal in some manner, such as by simply being cut down, allowing regrowth of a new pseudostem from the rhizome and the commencement of a new reproductive phase.

With annual production in 2017 of about 114 million tonnes of bananas (more than two thirds coming from within India, Brazil, China, Ecuador and the Philippines), it has been recognised that banana pseudostems represent a potentially valuable renewable resource, one which has been traditionally under-utilised and historically economically ignored by banana growers. There have thus been numerous attempts to use the pseudostems for the production of paper, due to the beneficial properties and qualities of the fibre in the pseudostems.

However, in a paper titled “Banana Stem Fibre for Papermaking” by S. K. Singhai, J. K. Garg and B. Biswas for the Indian Pulp and Paper Journal, August-September 1975, 30 (2), pp 13 to 15, the situation at that time was summarised as “The pulping and papermaking qualities of banana (M. sapientum and M. paradisica) stem fibre have been examined. From the available information given in this paper, it is to be considered that neither technically nor economically the use of banana stem fibre is a feasible proposition.” Thus, at least in the mid 70's, no sensible approach had yet been developed for the use of these materials for paper production.

Since then, it has continued to be recognised that banana pseudostem fibres should have suitable properties for paper production. In a paper titled “Plantain (M. Paradisiaca L) Pseudostem; A Fibre Source For Tropical Countries” by Nicholas A Darkwa of the Forestry Research Institute of Ghana, published in Book 2, TAPPI Proceedings, 1998 for the 1998 Pulping Conference in Montreal Quebec, it was concluded that “ . . . tropical countries that are deficient in long-fibred material for their pulp and paper production can utilise the pseudostems of plantain and banana for such purposes.”

Indeed, several attempts have been made to use banana plant refuse (predominantly pseudostems, which includes petioles and cores, and also leaves, immature inflorescence and unused bananas) in existing or modified paper pulping processes—see U.S. Pat. No. 5,958,182 for a short summary of some such processes.

However, such refuse commonly has an extremely high water and natural latex content and includes numerous resinous and gummy substances that are difficult to handle and process. In order to produce workable fibres having desirable characteristics for making paper, it has proven necessary to extract these fluids and, in particular, wash out the latex and other natural resinous substances, often with the use of chemicals and heat. This has proven to be technically difficult and has generally made the pulping of banana refuse for the production of paper uneconomic, particularly for bulk paper supplies and for anything other than boutique or artistic papers. It has also generally presented the manufacturers with significant chemical waste disposal issues.

In Australia, while it has been reported that a good quality paper can be made in low volume by combining and pulping banana fibre and betel nut husk (Areca catechu L.), Australian investigators have nonetheless concluded that the yield of banana fibre is too low for extraction in pulping processes to be economical. Indeed, in one Australian report, it was reported that only 1 to 4 oz (28-113 g) of suitable fibre could be obtained from 40 to 80 lbs (18-36 kg) of green pseudostems from a pulping process. Thus, 132 tonnes of green pseudostems would yield only 1 tonne of paper. The conclusion was thus that the pseudostem would have much greater value as organic matter chopped and left in the field to fertilize subsequent crops, which indeed is where the Australian banana growing industry finds itself today.

There have also been suggestions for the use of banana plants without pulping, such as the mechanical processes described in the applicant's own International patent publications WO2006/029469 and WO2010/071945. The mechanical processes described in these documents aim to avoid the pulping problem, firstly by generating sheets of fibres directly from the pseudostems of banana plants, and secondly by forming from those sheets a fibre furnish consisting essentially of plant petiole tissue where substantially longitudinally aligned petiole fibres have been cut generally laterally to form fibres with a fibre length distribution such that at least 95% of the fibres have substantially the same predetermined fibre length.

The present invention seeks to provide a further alternative to the use of wood and to provide an improved method and apparatus for the production of a cellulosic fibrous material suitable for use in, for example, vacuum moulding to form packaging items.

### SUMMARY OF THE INVENTION

The present invention provides a method for producing a mouldable cellulosic fibrous material from a cellulose fibre feedstock, the feedstock having a moisture content greater than about 80% (w/w), the method including:
mechanical pre-treatment of the feedstock to form a fibre furnish having fibres with a fibre length distribution such that at least 95% of the fibres have a length less than about 15 mm;
optionally, refining the fibre furnish in a high consistency disc refiner;
dewatering the fibre furnish without chemical addition, to produce a cellulose fibre cake and a filtrate, the cellulose fibre cake having a moisture content less than about 40% (w/w); and
refining the cellulose fibre cake in at least one disc refiner to produce the mouldable cellulosic fibrous material.

In one form, where the method includes the optional step of refining the fibre furnish in a high consistency disc refiner before the dewatering, the subsequent refining of the cellulose fibre cake will preferably be conducted in a single low consistency disc refiner. In another form, where the method does not include the optional step of refining the fibre furnish in a high consistency disc refiner before the dewatering, the subsequent refining of the cellulose fibre cake will preferably be conducted in a high consistency disc refiner in series with, and followed by, a low consistency disc refiner.

The mouldable cellulosic fibrous material produced by the inventive method is a pulp where the non-cellulosic components of the feedstock, such as hemicellulose, lignin, waxes, tannins and pectin have been substantially removed by mechanical means without the use of chemical additives and, apart from a final drying step conducted after the inventive method, without the need for the application of heat. The removal of these non-cellulosic components is advantageous due to the presence of these components in a product, and particularly on the surface of banana fibres for example, having been found to hinder interfacial bonding between fibres.

In this respect, the mouldable cellulosic fibrous material produced by the method of the present invention has been found to retain preferred physical and mechanical properties of the feedstock, within a relatively narrow size distribution, as will be discussed below. The inventive method also provides the ability to control the surface roughness of fibres in the feedstock, allowing for the tailoring of those fibres to suit different moulding process requirements.

Turning to a description of the feedstock for the method of the present invention, the feedstock is preferably a cellulose fibre feedstock formed from plant petioles, where the fibres are derived only from (or substantially from) plant petiole tissue. In relation to this use of the word “substantially”, a skilled addressee will understand that with any natural product derived from plants, there is likely to be some degree of contamination (or undesirable material) present that cannot be avoided in a feedstock and thus usually also in a final product. Therefore, the presence of contamination amounts of other material in the feedstock and the mouldable cellulosic fibrous material produced therefrom is not to be excluded.

Ideally, the plant petioles used for the feedstock for the inventive method will be reasonably fresh, preferably having been harvested for no more than up to about 10 days, depending upon weather and soil contamination.

It will also be appreciated that certain types of plants are likely to form petioles of more practical use in the formation of a suitable feedstock than others. For example, a relatively small plant may form petioles that are too small (either in length or in width) to allow feedstock preparation in a suitable or economic manner, or may have an insufficiently sized pulvinus (basal enlargement) to produce an “outer portion” of the preferred type described above in relation to the pseudostem of banana plants.

It is envisaged that the most suitable form of plant petiole for use as the feedstock for the method of the present invention will be the petioles from banana plants in the family Musaceae. Exemplary banana plants within the family Musaceae include the genera Musella, Musa and Enseta. Alternatively, plant petiole tissue from other plants such as members of the Zingiberales order, especially the Strelitziaceae family could also be used as the feedstock for the method of the present invention.

Although not to be limited thereto, the following description of the present invention will thus predominantly relate to its use with a feedstock in the form of the pseudostem of edible-fruited banana plants, such as those belonging to the species Musa acuminata (such as the well known bananas “Cavendish” and “Lady Finger”), Musa balbisiana, or to the hybrids Musa paradisiaca (often referred to as “plantain”) and Musa sapientum.

Irrespective of the source and type of the feedstock material, the feedstock will have a moisture content greater than about 80% (w/w), preferably greater than about 85% (w/w), more preferably greater than about 90% (w/w), and most preferably greater than about 95% (w/w). In this respect, the edible-fruited banana plants mentioned above will ordinarily have a moisture content greater than about 90 to 95% (w/w) which is useful for the subsequent mechanical method steps of the present invention.

The mechanical pre-treatment of the feedstock ideally forms a fibre furnish having fibres with a fibre length distribution such that at least 95% of the fibres have a length less than about 15 mm. Preferably, the fibre length distribution of the fibre furnish will be such that at least 95% of the fibres have a length less than about 10 mm. More preferably, the fibre length distribution of the fibre furnish will be such that at least 95% of the fibres have a length less than about 5 mm. Most preferably, the fibre length distribution of the fibre furnish will be such that at least 95% of the fibres have a length less than or equal to about 3 mm. In preferred forms, at least 98% of the fibres in the fibre furnish will have substantially the same predetermined fibre lengths mentioned above

In this respect, it has been found to be advantageous for the efficient functioning of the subsequent refining steps if the length of the fibres in the fibre furnish is controlled to within these preferred ranges. It has also been found that the subsequent moulding of the mouldable cellulosic fibrous material produced by the inventive method is easier if the length of the fibres in the fibre furnish is controlled to within these preferred ranges.

The mechanical pre-treatment step has a main aim of providing fibre furnish with such a controlled fibre length, but also desirably commences the fibre separation process known as ‘fibrillating’.

In one form, the mechanical pre-treatment of the feedstock may include a process that removes sheets of fibres from the outer portion of a pseudostem by virtue of separation between bundles of fibres (about the periphery of the pseudostem), ideally as the pseudostem is rotated. This allows for separation in a manner that retains the integrity of the fibre bundles along virtually the entire length of the pseudostem and thus along a continuously removed sheet.

For example, substantially longitudinally aligned petiole fibres may be obtained from plant petiole tissue by the process for removing sheets of fibres from the outer layer of a pseudostem as is described in the abovementioned International patent publication WO2006/029469, the entire contents of which are also hereby incorporated by reference.

With this in mind, a suitable mechanical pre-treatment of the feedstock can more specifically be a process for producing sheets from the pseudostems of banana plants in the family Musaceae that includes the steps of feeding a pseudostem into a workstation, supporting the pseudostem for rotation thereof about its longitudinal axis within the workstation, and contacting the rotating pseudostem along substantially its entire length with a fibre-separating device, such that a continuous sheet of fibre is removed from the pseudostem by the fibre-separating device during rotation. In this form, sheets are removed in this manner only as far as the core of the pseudostem.

Sheets produced in this manner are thus continuous sheets removed peripherally from the pseudostems, much as one would peel a layer of paper off a toilet roll. The sheets are continuous in that they are preferably as wide as the pseudostem is long, and they are preferably only as long as is manageable for their subsequent handling. Of course, they will also only be as long as is feasible given the diameter of a particular pseudostem and the desired thickness of the sheet.

Once such sheets of substantially longitudinally aligned petiole fibres have been removed from the pseudostem, the mechanical pre-treatment of the feedstock may be continued by the fibres of the sheets then being cut generally laterally to a required fibre length. In one form, a cutting process such as the one described in the abovementioned International patent publication WO2010/071945 may be undertaken, using a cutting device that is able to receive the removed sheets and pass them through an arrangement of either low- or high-speed cutting discs in the form of cutting blades or grinders set to a specific cutting width, and operating so as to cut the substantially longitudinally aligned petiole fibres generally laterally (and ideally at an angle within the range of 85° to 95°, and more preferably at about) 90° to the cutting discs. The cutting device thus produces strips of parallel fibres of substantially the same length.

Preferably, the cutting device additionally includes a further cutting mechanism arranged to further cut or separate the parallel fibres perpendicularly to the above generally lateral cut, thus further cutting the strips of parallel fibres into fibre segments, having a number of fibres with lengths controlled to within the abovementioned preferred ranges, to produce one form of fibre furnish for use in the subsequent steps of the method of the present invention.

In another form of mechanical pre-treatment, substantially longitudinally aligned petiole fibres may be obtained from plant petiole tissue by a process of cutting disc shaped slices from a pseudostem, using either a swinging blade, such as a chaff cutter, or a fibre production unit similar to, but larger than, the one described in the abovementioned International patent publication WO2010/071945, modified so as to be able to accept a whole pseudostem rather than just sheets from a pseudostem.

For example, such a modified mechanical pre-treatment apparatus might be able to both shear a pseudostem, producing a leaf-like fibre of less than about 15 mm, 10 mm, 5 mm or most preferably equal to or less than 3 mm, and also impact, such as by compressing, crushing or beating those fibres so as to render them more flexible and commence or continue the fibrillation process. Such apparatus might, for example, utilise a chamber that is able to receive sheared fibres and simultaneously reduce in volume so as to compress or crush the sheared fibres to produce a desirable (fibrillated) fibre furnish. Additionally, by combining shearing and impact actions, shreds of fibres may be produced which are also partially dewatered by the impact forces.

In one or more of these forms of mechanical pre-treatment, it can be advantageous for there to be fibres of a consistent fibre length, such as the fibre length distribution of at least 95% as mentioned above, as all of the alpha cellulose is contained in parallel bundles which run up from the ground to the tip of the plant. Keeping and preserving this natural order while slicing, instead of randomly cutting or grinding or milling, has been found to be beneficial, although not essential, as it can result in a more consistent fibre length and can tend to open the plant structure, which advantageously allows for mere mechanical compression to squeeze plant sap out in a subsequent dewatering process.

In addition to the inventive method mentioned above, the present invention also provides apparatus for producing a mouldable cellulosic fibrous material from a cellulose fibre feedstock, the feedstock having a moisture content greater than about 95% (w/w), the apparatus including:
mechanical pre-treatment apparatus capable of forming a fibre furnish from the feedstock, the fibre furnish having fibres with a fibre length distribution such that at least 95% of the fibres have a length less than about 15 mm;
optionally, a high consistency disc refiner for refining the fibre furnish;
a dewatering press for dewatering the fibre furnish to produce a cellulose fibre cake and a filtrate, the cellulose fibre cake having a moisture content less than about 40% (w/w); and
at least one disc refiner to produce the mouldable cellulosic fibrous material from the cellulose fibre cake.

In one form, where the apparatus includes the optional high consistency disc refiner before the dewatering press, the subsequent refining of the cellulose fibre cake to produce the mouldable cellulosic fibre material will preferably be conducted in a single low disc refiner. In another form, where the apparatus does not include the optional high consistency disc refiner before the dewatering press, the subsequent refining of the cellulose fibre cake to produce the mouldable cellulosic fibre material will preferably be conducted in a high consistency disc refiner in series with, and followed by, a low consistency disc refiner. In both forms, the dewatering press is preferably a screw press.

In the method and apparatus of the present invention, the dewatering preferably occurs in a screw press in two passes, either continuously or as a batch process, with the first pass ideally removing greater than about 95% (w/w) of the moisture, due to gradual compression within a screw press and also due to friction between adjacent fibres and the wall of the screw press. In this form, in the second pass, water may be added to the material entering the screw press to assist with the removal of any residual impurities on the surfaces of the fibres, to further assist with the interfacial bonding and mechanical interlocking therebetween, to form the cellulose fibre cake (preferably a banana fibre cake). In this respect, with the operation and interaction of the inventive method steps and apparatus, it has been found that there is no essential need for the addition of any of the pulping chemicals traditionally adopted in paper making processes, such as chlorine, hypochlorites, sulfite salts, caustic soda, sodium sulfide, sulfurous acid, dextrin, oxidised starch, styrene butadiene latex or styrene acrylic, for example.

Further in relation to the dewatering stage, a screw press is preferred as a screw press ideally conveys material along the inside of a permeable cylinder, by way of a slowly-rotating Archimedean screw, preferably with a tightening pitch where the separation between the flights of the screw progressively decrease, within a perforated cylindrical screen. The screw press is preferably inclined to the horizontal to assist with the draining of the filtrate into a sump or the like through the screen perforations.

A pressure of at least 0.5 kg/cm² is preferred for the dewatering step, regardless of how many passes are adopted, but it will be appreciated that the determination of the desired pressure is ideally done empirically for different materials and different plant types. This preferred gradual pressurisation, and the subsequent friction between adjacent fibres and surfaces, will preferably be sufficient to separate the fibres to permit fluids to be extracted, without weakening the cell structure or losing the natural attributes of the fibres. It is expected that the preferred pressures for a dewatering step will be in the range of 0.5 kg/cm² to 2.0 kg/cm².

Ideally, the screen perforations include a series of staggered elongate, oval-shaped, openings, preferably between 20 mm and 60 mm long, but ideally about 40 mm long, each having a mesh configured as a series of, for example, diamond-shaped perforations formed from flexibly arranged, interlocked wires. In this form, the wires preferably flex during operation, permitting the mesh to extend outwardly to form a generally concave shape during use. In this form, as fibre travels through the screen perforations, the mesh flexes and extends with the diamond-shaped gaps expanding from a width of about 1 mm to a width of about 2 to 2.5 mm.

The tightening pitch of the preferred dewatering apparatus is ideally adopted to impart mechanical stress to material during the dewatering. In this respect, it will be noted that the material input into the dewatering step may be in the form of fibrous chips of substantially equal length, but of varying width and thickness. In this form, the tightening pitch assists in providing a constant mechanical stress that forces the feedstock to work on itself and the outer screen surfaces. Subsequently, the volume of the fibre reduces due to the loss of fluid exiting through the screen slits and the conical configuration of the screw. The continuous action of the fibre chips, the mechanical pressure and the friction between adjacent surfaces maintains the extraction of fluids from the feedstock fibres passing therethrough.

The preferred geometry of the screw in the screw press is such that relative movement is applied between, as mentioned above, fibres in the material and the walls of the press and the screen, as well as between each other. This interaction ideally separates fibre bundles without reduction of the fibre length. This relative movement creates enough friction to prepare the fibre surface to enable interfacial bonding and to remove any remaining non-cellulosic compounds at the fibre surface, which is preferred in order to prepare the cellulose fibre cake prior to subsequent refining steps, to assist the refining step to prepare and improve the surface roughness of the fibres, increasing their surface area to maximise interfacial bonds in the final product.

As mentioned above, the dewatering screw press produces a liquid filtrate and a dewatered solid in the form of a cellulose fibre cake with a moisture content preferably less than about 40% (w/w).

The liquid filtrate produced in the dewatering step is ideally predominantly plant sap, with a chemical composition that will be generally understood by a skilled addressee, with reference to the nature and type of the feedstock used in the method. In general terms, the liquid filtrate includes organic acids, nutrient elements and growth regulators and, where banana plants provide the feedstock, the organic acid concentrations are relatively high and the components include beneficial compounds like gibberellic acids and cytokines and also more conventional soil improving elements such as nitrogen, phosphorous, potassium, magnesium and calcium. As a by-product of the method of the present invention, the liquid filtrate is expected to be usable as an organic liquid fertiliser.

As mentioned above, following the dewatering step, the cellulose fibre cake moves on to a final refining step, being a step where the fibres of the cellulose fibre cake are finally physically modified, essentially by fibrillation and roughening. A variety of fibre end-properties can be a direct result of this refining of the cellulose fibre cake. For example, if the fibre length is decreased, the strength and resistance to tearing of the end product produced will decrease, but the surface levelness and smoothness will increase, and the print quality will become better. As the degree of refining is increased, the density, hardness, ink holdout, smoothness, and internal bond strength will increase, but thickness, compressibility, dimensional stability, and porosity will decrease. Complicating matters is the fact that with initial refining, resistance to tearing will increase, due to the enhanced ability of the fibres to bond with each other and resist pulling away, but further refining will work to decrease tearing resistance, as the shortening of the fibres has a deleterious effect on fibre strength. In other words, increased refining will work to shorten fibres, which enhances smoothness and printability, but diminishes strength and resistance to stresses.

In the present invention, it has been found to be particularly beneficial where no refining is conducted before the dewatering step, if the cellulose fibre cake produced in the dewatering step is then refined in a high consistency disc refiner, followed thereafter by a low consistency disc refiner, to produce a preferred mouldable cellulosic fibrous material. Of course, and as mentioned above, where refining is conducted in a high consistency disc refiner before the dewatering step, then this subsequent refining may only need to be conducted in a single low consistency disc refiner.

Disc refiners provide flexibility that permits customisation of a fibre processing process, which assists with allowing specific metrics in refining performance to be met, ideally suiting a range of subsequent fibre pulp moulding lines that might use the mouldable cellulosic fibrous material produced by the present invention.

A disc refiner typically consists of two vertical discs with serrated or otherwise contoured surfaces. One disc (the “rotor”) rotates clockwise, while the other disc (the “stator”) either remains stationary to provide relative rotation therebetween. Alternatively, two rotor discs may be utilised, rotating in opposite directions to provide the relative rotation. A rotor and stator will ideally have on one side a “pattern”, which might alternately consist of blades (or bars) and crevices (or grooves).

The cellulose fibre cake produced, in one form of the invention in the dewatering stage or in another form as a direct product of the mechanical pre-treatment stage, may be pumped between the discs of a disc refiner, ideally through an inlet in the centre of one disc. As centrifugal force pushes the fibres out toward the perimeter of the discs, the abrasion experienced between the discs by the fibres tends to delaminate and internally fibrillate the fibres to the degree desired, increasing the tensile and burst strength of the fibres, improving the fibres flexibility and increasing the relative bonding area between fibres. The space between the discs can be widened or shortened, depending on the extent of refining required.

With regard to disc refiners, a reference to “consistency” is a reference to a dry weight percentage of a fibre in suspension, with a “low consistency” disc refiner thus being a disc refiner that is configured to operate on a material containing in the order of 1 to 5% fibre, while a high consistency disc refiner is one that is configured to operate on a material containing in the order of 15 to 40% fibre. Therefore, in the preferred form of the invention where high consistency refining is followed by low consistency refining, fresh water will be added to the refined product leaving the high consistency disc refiner before it enters the low consistency refiner in order to alter the moisture content and thus the consistency of the product to be further refined.

In low and high consistency disc refiners, the process sides of the discs are fitted with metal refining plates which are covered with a variety of raised bars. In a preferred form, a screw type or ribbon type feeder delivers a constant flow of high consistency cake into the centre of the space between the two discs. Refining takes place as the fibres travel outward between the bars of opposite discs as the rotor rotates. In this form, the rotor may be driven by a large motor and a smaller motor may be used to adjust the gap (opening and/or closing) between the plates. In this respect, it will be appreciated that low consistency disc refining tends to be more energy efficient compared to high consistency disc refining, principally due to the different dry fibre content levels operated upon in each, and also due to the configuration of bars and grooves tending to be accordingly tighter and shallower.

Finally, it will be appreciated that the mouldable cellulosic fibrous material produced by the refining step will subsequently be dried in a suitable manner and to a suitable extent, depending upon the use to which that material will ultimately be put.

The mouldable cellulosic fibrous material will have ideally increased its fibre length by more than about 10%, with the width of the fibre ideally decreasing by more than about 15%, with fibre coarseness ideally reducing by about 10%. The amount of kinked or broken fibres is able to be reduced by the method of the present invention, and the fibre softness tends to be improved compared to the fibres of the original feedstock. Additionally, with the preferred form of feedstock being plant petiole tissue from banana plants in the family Musaceae, the subsequently produced fibrous material tends to be malleable, expressed as an improved foldability index number, as well as being strong in tension such that the fibres tend to bend rather than snap or break. It will be understood that this allows the use of longer fibres and the formation of moulded products that can have tight curves and intricate shapes, which might otherwise not be possible with stiff short fibres.

Advantageously, the method of the present invention provides for a lower cost process, not simply because the preferred feedstock has traditionally been regarded as a waste material, but because the method utilises simple and quick, low energy mechanical steps, without the need for high temperature processing stages and without the need for the traditional chemical additives.

### BRIEF DESCRIPTION OF THE DRAWINGS

An embodiment will now be described, by way of example only, with reference to exemplary apparatus that can be used to produce the mouldable cellulosic fibrous material mentioned above. However, it is to be appreciated that the following description of the accompanying drawings only exemplifies one way of putting the present invention into practice. The following description is thus not to be read as limiting the above general description.

In the accompanying drawings:

FIG. 1 is a schematic cut-away view of one form of apparatus capable of removing sheets of substantially longitudinally aligned petiole fibres, showing the relationship of the pseudostem to a fibre-separating device;

FIGS. 2a and 2b are successive operational views of a pseudostem in the apparatus of FIG. 1, showing the diameter of the pseudostem reducing as sheets are removed;

FIGS. 3a and 3b are schematic illustrations of one form of apparatus suitable for receiving those sheets of substantially longitudinally aligned petiole fibres and producing a fibre furnish suitable for use as the feedstock for the method of the present invention;

FIG. 4 is a flowsheet that schematically illustrates a preferred embodiment of a method according to the present invention;

FIGS. 5(a) and 5(b) are schematic illustrations of a preferred form of dewatering screw press for use with the preferred embodiment of FIG. 4; and

FIG. 6 is a schematic illustration of a preferred form of disc refiner for use with the preferred embodiment of FIG. 4.

### DETAILED DESCRIPTION OF THE PREFERRED EMBODIMENT

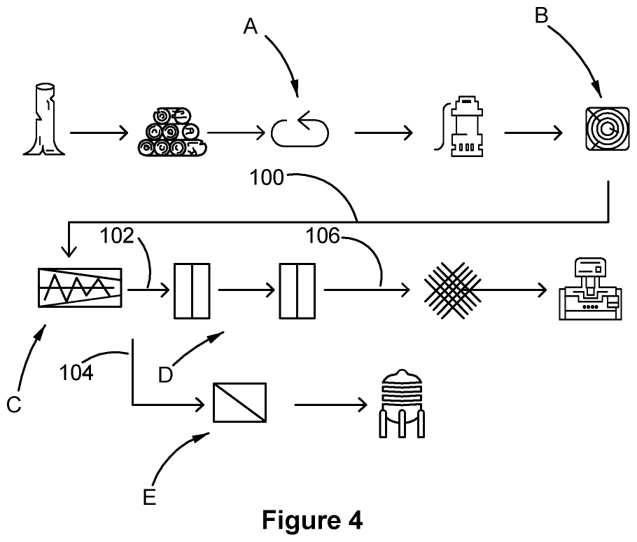

Before turning to a more detailed description of the method and apparatus illustrated in FIGS. 4, 5(a), 5(b) and 6, it is helpful to firstly illustrate various aspects an ideal form of cellulose fibre feedstock and one form of mechanical pre-treatment apparatus suitable for use in the method of this invention.

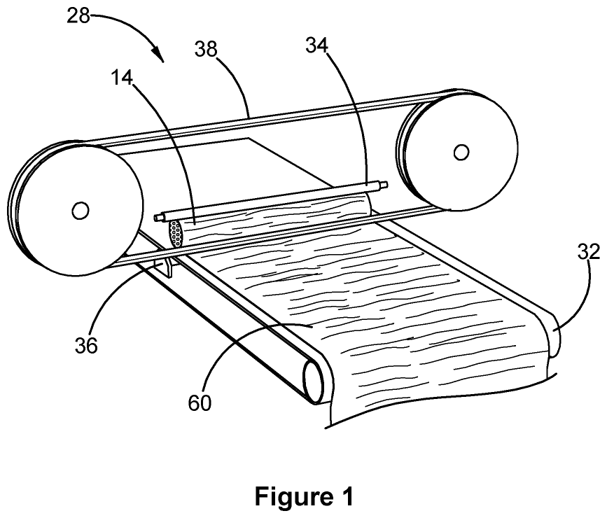

It is envisaged that the most suitable form of feedstock for use with the present invention is the petioles of banana plants in the family Musaceae including the genera Musa and Enseta. With this in mind, FIG. 1 shows the general operation of one aspect 28 of one form of a suitable mechanical pre-treatment apparatus, described in terms of its use on a pseudostem 14. In terms of its operation, the apparatus 28 includes a fibre-separating device in the form of a longitudinally moving blade 38 that is configured and constrained so as to move substantially parallel to the longitudinal axis of the pseudostem 14, along its entire length, in a single pass. This figure has been adopted from the abovementioned International patent publication WO2006/029469, the entire contents of which are hereby incorporated by reference for the purpose of describing such an ideal sheet removal apparatus and process for use as a part of the mechanical pre-treatment apparatus in this embodiment.

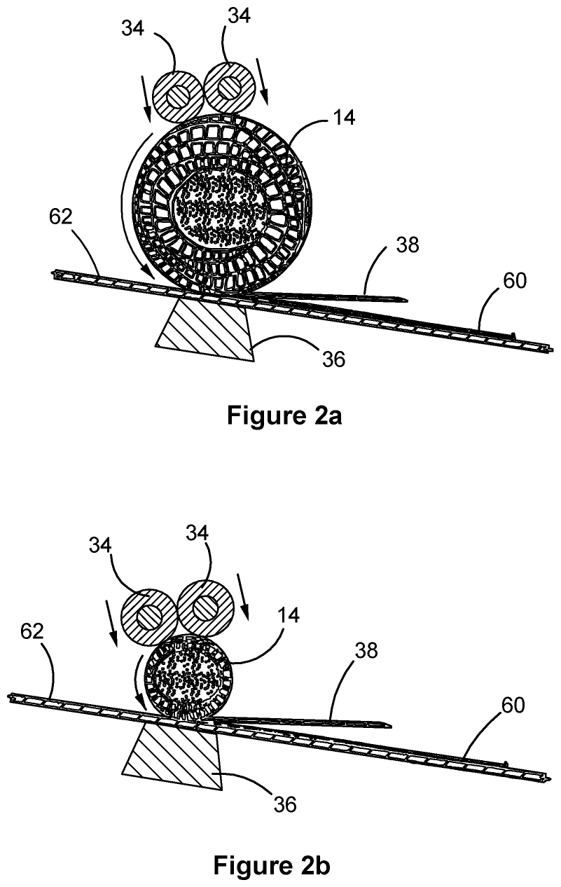

FIG. 2a shows the pseudostem 14 having a diameter of about 150 mm, which is a typical starting diameter for a rounded-up pseudostem fed into a workstation. FIG. 2b shows the pseudostem 14 after it has been operated upon for some time, and after a continuous sheet 60 has been separated therefrom, the pseudostem 14 now having a reduced diameter of about 75 mm. Also shown in FIGS. 2a and 2b is a conveyor belt 62 upon which the pseudostem 14 will rest, supported thereunder by a support member 36. Upper support rollers 34 are also evident.

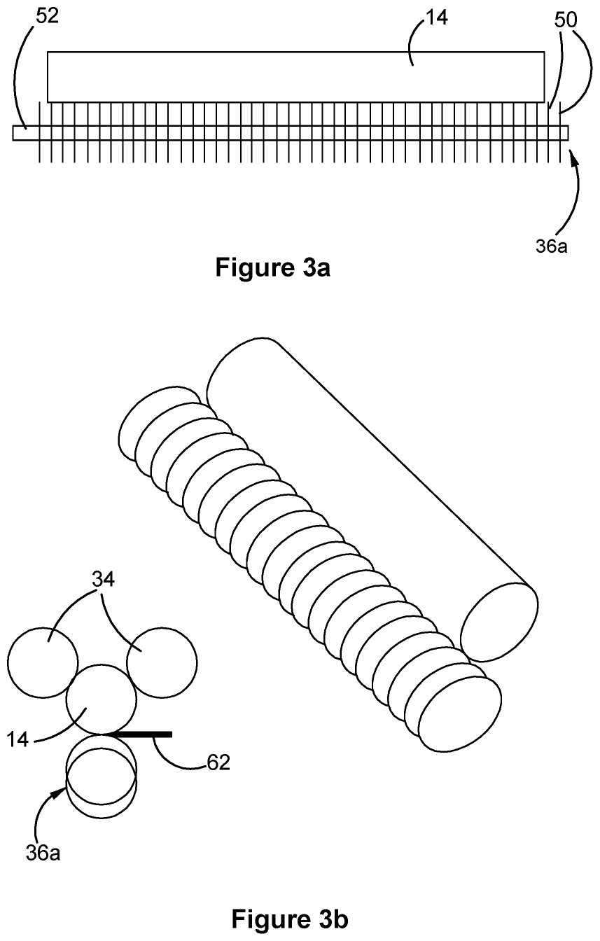

FIGS. 3a and 3b show the general operation of a second aspect 28 of one form of a suitable mechanical pre-treatment apparatus, that can be adopted as a modification to the apparatus of FIGS. 2a and 2b, where the support member 36 is replaced by a support roller 36a in the form of a nose roller including a plurality of very thin cutting discs 50 (or very thin grinding wheels) spaced along a shaft 52 at regular intervals, the intervals being representative of the predetermined fibre length mentioned above. In this form, and as is evident in the schematic of FIG. 3b, the sheet being removed from the pseudostem 14 upon the conveyor belt 62 is thus able to be cut generally laterally to form strips of longitudinally aligned fibres with the preferred predetermined fibre length set by the intervals between the cutting discs 50, those predetermined fibre lengths being of the types mentioned above in the general description.

The strips may then be subsequently processed to further separate the longitudinally aligned fibres into smaller packets or bundles of fibres, or into individual fibres loosely arranged, as desired, to prepare a preferred form of fibre furnish for use with subsequent steps of the method of this preferred embodiment of the present invention.

The following table (Table 1) illustrates physical and chemical characteristics of ideal fibre furnishes prepared by a mechanical pre-treatment step, being with either the mechanical pre-treatment apparatus illustrated in FIG. 1, 2a, 2b, 3a or 3b, or with suitable mechanical pre-treatment apparatus of other envisaged embodiments.

TABLE 1
Ideal range of physical fibre furnish properties

| Width or | | | Microfibrillar | Young's | Failure | Tensile | |
|---|---|---|---|---|---|---|---|
| diameter | Density | Cell I/D | Angle | Modulus | Strain | Strength | Elongation |
| (μm) | (kg/m³) | ratio | (degree) | (GPa) | (%) | (MPa) | (%) |
| 50-350 | 1050-1450 | 50-200 | 10-35 +/− 2 | 8-60 | 1-5 | 50-1000 | 3-20 |

Ideal range of chemical fibre furnish properties

| | Hemi- | | | |
|---|---|---|---|---|
| Cellulose | cellulose | Lignin | Pectin | Moisture |
| (wt %) | (wt %) | (wt %) | (wt %) | (wt %) |
| 50-80 | 6-25 | 5-15 | <1.5 | 8-12.5 |

Referring now to the flowsheet of FIG. 4, it can be seen that a suitable method includes the mechanical pre-treatment steps described above of a banana tree round-up process A (described with reference to FIGS. 1, 2(a) and 2(b)) and a slitting and dicing process B (described with reference to FIGS. 3(a) and 3(b)), followed by subsequent method steps of this preferred embodiment of the present invention. The subsequent steps in this embodiment are the step of dewatering C of the fibre furnish 100 in a dewatering press (to be described below) to produce a cellulose fibre cake 102 and a filtrate 104, and subsequently refining D the cake 102 in two disc refiners (also to be described below) to produce the mouldable cellulosic fibrous material 106 which can be subsequently used for the production of moulded fibre packaging products. The filtrate 104 can be passed through a further filter E before being stored for later use.

With respect to exemplary operation parameters and conditions for the subsequent method steps of FIGS. 4, 5(a), 5(b) and 6, reference is made to the following:

A, B, C—Mechanical Pre-Treatment and Dewatering

| | | |
|---|---|---|
| Shredding and Dewatering Capacity | 3 | tonne/hr |
| Banana Plantation Waste Input | 1 | tonne/hr |
| Moist Banana Fibre Output | 0.47 | tonne/tonne waste |
| Banana Sap Output | 0.5 | tonne/tonne waste |
| Current System Losses | 0.03 | tonne/tonne waste |

Filtrate Preparation/Treatment

| | | |
|---|---|---|
| Filtrate Production Capacity | 1.5 | tonne/hr |
| Banana Sap Input | 0.5 | tonne |
| Total Additives Input | 0.046 | tonne |
| Total Filtrate Output | 0.540 | tonne |
| System Losses | 0.006 | tonne |

D—Disc Refining

| Fibre Refining Capacity | 10 | m³/hr |
|---|---|---|
| Fibre Input | 0.47 | tonne |
| Water Rate per tonne fibre | 4 | |
| Water | 1.88 | m³/tonne |
| Suspended Refined Fibre Output | 2.349 | m³/tonne |
| System Losses | 0.001 | m³/tonne |

Exeplary Moulded Product Production

| | | |
|---|---|---|
| Moulded Product Production Capacity | 5000 | pieces/hr |
| Suspended Refined Fibre Input | 2.349 | m³/tonne |
| Total Additives | 0.0036 | tonne |
| Electricity | 56.352 | Kwh |
| Fuel | 19.5 | Litre |
| Number of Moulded Products Output | 2348 | Pieces |
| Weight of Moulded Products Output | 0.1174 | tonne |
| System Losses | 0.001 | m³/tonne |

Exemplary Product Specification (Trays)

| Moulded tray weight | 0.00005 tonne |
|---|---|
| Moulded trays per tonne | 20,000 |
| Moulded trays per m³ of susp fibre | 1,000 |

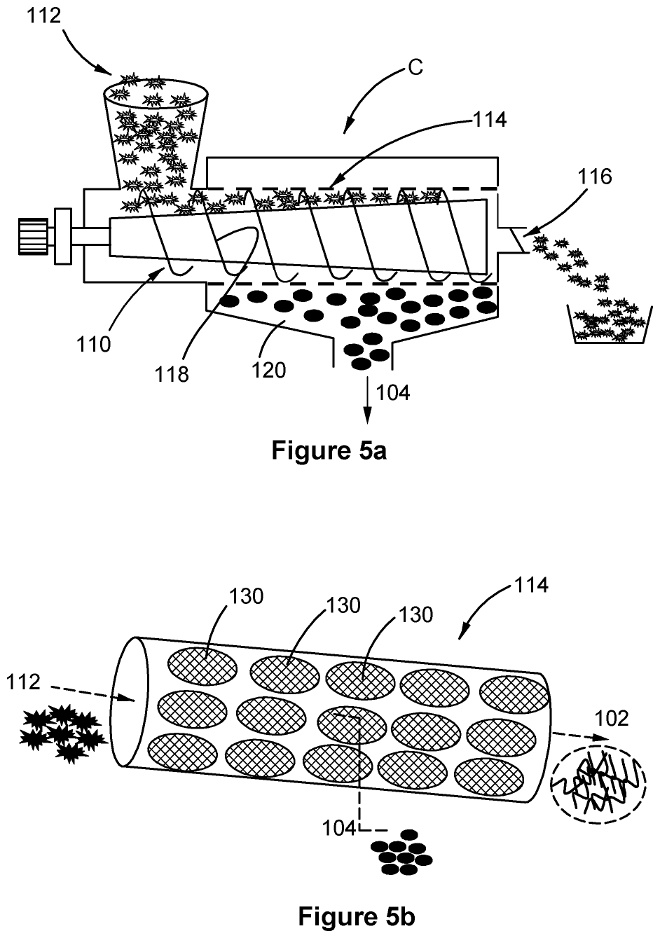

Turning to a description of the apparatus, as mentioned above, the dewatering C ideally occurs in two passes, in this embodiment in a batch process with the first pass removing greater than about 95% (w/w) of the moisture within the fibre furnish 100, due to gradual compression within a screw press 110 and also due to friction between adjacent fibres 112 and the perforated wall 114 of the screw press 110—see description of FIGS. 5(a) and 5(b) below. In the second pass, water is added to the material entering the screw press 110 to assist with the removal of any residual impurities on the surfaces of the fibres 112, to further assist with the interfacial bonding and mechanical interlocking therebetween, to form the cellulose fibre cake 116.

It is envisaged that in other embodiments two similar screw presses 110 could be utilised, configured in series, so that the dewatering can occur continuously but still in two dewatering passes.

Referring more specifically to FIGS. 5(a) and 5(b), the screw press 110 of this embodiment conveys the fibre furnish 100 in the form of fibres 112 along the inside of the perforated wall 114 in the form of a permeable cylindrical screen, by way of a slowly-rotating Archimedean screw 118 with a tightening pitch. The screw press 110 includes a sump 120 to assist with the draining of the filtrate 104, via the screen perforations 130 seen in FIG. 5(b).

In this respect, the screen perforations 130 include a series of staggered elongate, oval-shaped, openings about 40 mm long, each having a mesh configured as a series of diamond-shaped perforations formed from flexibly arranged, interlocked wires, such that the wires can flex during operation, permitting the mesh to extend outwardly to form a generally concave shape during use. In this form, as fibre travels through the screen perforations 130, the mesh flexes and extends with the diamond-shaped gaps expanding from a width of about 1 mm to a width of about 2 to 2.5 mm.

A pressure of at least 0.5 kg/cm² is preferred for the dewatering step C, regardless of how many passes are adopted, but it will be appreciated that the determination of the desired pressure is ideally done empirically for different feedstocks and different plant types. It is expected that the preferred pressures for the dewatering step C will be in the range of 0.5 kg/cm² to 2.0 kg/cm².

The tightening pitch of the screw press 110 is adopted to impart mechanical stress to the fibre furnish 100 during the dewatering. In this embodiment, the fibre furnish 100 input into the dewatering step C is in the form of fibrous chips 112 of substantially equal length, but of varying width and thickness. The tightening pitch assists in providing a constant mechanical stress that forces the chips 112 to work on themselves, the screw 118 and the interior of the perforated wall 114. The volume of the fibre chips 112 reduces due to the loss of fluid exiting through the screen perforations 130.

The liquid filtrate 104 produced in the dewatering A is predominantly plant sap, with a chemical composition that will be generally understood by a skilled addressee, with reference to the nature and type of the feedstock used in the method. In general terms, the liquid filtrate includes organic acids, nutrient elements and growth regulators and, where banana plants provide the feedstock, the organic acid concentrations are relatively high and the components include beneficial compounds like gibberellic acids and cytokines and also more conventional soil improving elements such as nitrogen, phosphorous, potassium magnesium and calcium. As a by-product of the method of the present invention, the liquid filtrate is expected to be usable as an organic liquid fertiliser.

As mentioned above, the dewatering A produces a dewatered solid in the form of a cellulose fibre cake 116 with a moisture content less than about 40% (w/w). At this stage however, the physical characteristics of the fibres in the cellulose fibre cake 116 are not likely to have been modified from the form of the fibres in the original fibre furnish 100, particularly given that this embodiment does not include the use of high consistency disc refiner before the dewatering stage.

Returning to the flowsheet of FIG. 4, following dewatering C, in this embodiment the cellulose fibre cake 102 moves on to the refining step D, being a step where the fibres of the cellulose fibre cake are physically modified. In this embodiment, it has been found to be particularly beneficial if the cellulose fibre cake 102 is refined in two disc refiners, first in a high consistency disc refiner, followed thereafter by a low consistency disc refiner, and two disc refiners are represented in FIG. 4 at the refining step D. However, it is to be appreciated that any suitable number of disc refiners may be used, including one, two, three, four or more, preferably in series to maximise or improve the refining activity occurring, or for other reasons.

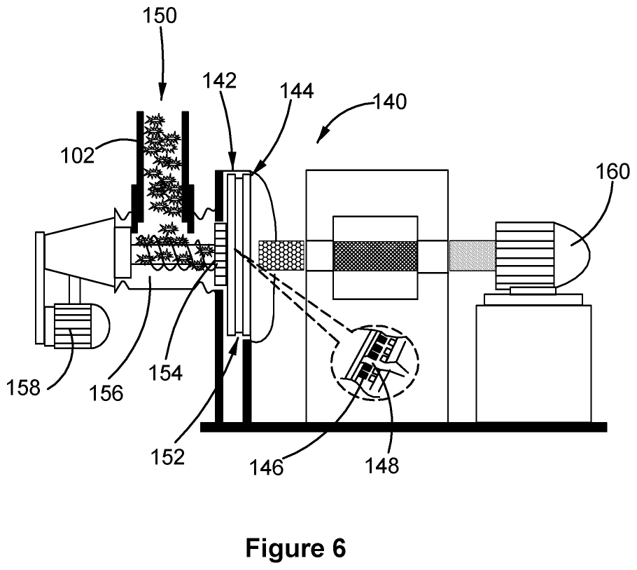

The disc refiner 140 of FIG. 6 consists of two vertical discs with serrated or otherwise contoured surfaces. One disc (the “rotor” 142) rotates clockwise, while the other disc (the “stator” 144) remains stationary to provide relative rotation therebetween. The rotor 142 and the stator 144 both have, on their respective interior sides, facing each other, a “pattern” which alternately consists of blades (or bars 146) and crevices (or grooves 148).

The cellulose fibre cake 102 is pumped via inlet 150 by a screw-type feeder 156 to the space 152 between the discs 142,144 of the disc refiner 140, through an inlet 154 in the centre of one disc 142. As centrifugal force pushes the fibres out toward the perimeter of the discs 142, 144, the abrasion experienced between the discs 142,144 by the fibres tends to delaminate and internally fibrillate the fibres to the degree desired, increasing the tensile and burst strength of the fibres, improving the fibres flexibility and increasing the relative bonding area between fibres. The space 152 between the discs 142,144 can be widened or shortened, depending on the extent of refining required. The rotor 142 and screw-type feeder 156 are driven by a large motor 158 and a smaller motor 160 may be used to adjust the space 152 (opening and/or closing) between the discs 142, 144.

As mentioned above, the reference to “consistency” is a reference to a dry weight percentage of a fibre in suspension, with a “low consistency” disc refiner thus being a disc refiner that is configured to operate on a material containing in the order of 1 to 5% fibre, while a high consistency disc refiner is one that is configured to operate on a material containing in the order of 15 to 40% fibre. In this embodiment, where two disc refiners of the type illustrated in FIG. 6 are utilised in series, such that high consistency refining is followed by low consistency refining, fresh water is added to refined product leaving the high consistency disc refiner before it enters the low consistency refiner in order to alter the moisture content and thus the consistency of the product to be further refined.

With reference to preferred forms of disc refiners for use with this preferred embodiment of the present invention, the following general specifications are regarded as ideal:
Type: double disc refiner
Disc size: 380 mm diameter
Capacity (TPD): 20-22
Consistency (%): 5 (low)-20 (high)
Motor Power (HP): 25
Refiner RPM: 1460
Groove width: 2 mm
Rib width: 2 mm
Inlet stock pressure: 0.1 Mpa
Body type (eg: cast iron): cast iron

With reference to preferred forms of dewatering apparatus for use with this preferred embodiment of the present invention, the following general specifications are regarded as ideal:
Type: Multi-disc sludge dewatering press-expeller cone shaped screw with a screen housing.
Max Hydraulic flow (m3/h): 4 to 6
Max solids load (kg/h): 400 to 600
Diameter: 600 to 400 mm
Length: 2.4 m
Dehydration Method: Action film spiral dehydration-screen housing with slits
Cake Moisture: Content (%) 90

Finally, it will be appreciated that this embodiment has been described by way of example only, and that variations and modifications within the spirit and scope of the invention are also envisaged.

1. A method for producing a mouldable cellulosic fibrous material from a cellulose fibre feedstock, the feedstock having a moisture content greater than about 80% (w/w), the method including:
mechanical pre-treatment of the feedstock to form a fibre furnish, the fibre furnish having fibres with a fibre length distribution such that at least 95% of the fibres have a length less than about 15 mm;
optionally, refining the fibre furnish in a high consistency disc refiner;
dewatering the fibre furnish without chemical addition to produce a cellulose fibre cake and a filtrate, the cellulose fibre cake having a moisture content less than about 40% (w/w); and
refining the cellulose fibre cake in at least one disc refiner to produce the mouldable cellulosic fibrous material.

2. The method according to claim 1, wherein the feedstock has a moisture content greater than about 85% (w/w), greater than about 90% (w/w), or greater than about 95% (w/w).

3. The method according to claim 1, wherein the feedstock is formed from plant petioles, where the fibres are derived at least substantially from plant petiole tissue.

4. The method according to claim 1, wherein the feedstock is formed from petioles from banana plants in the family Musaceae, including the genera Musella, Musa and Enseta.

5. The method according to claim 1, wherein the feedstock is plant petiole tissue in the form of substantially longitudinally aligned petiole fibres from banana plants in the family Musaceae including the genera Musella, Musa and Enseta.

6. The method according to claim 1, wherein the feedstock is plant petiole tissue in the form of substantially longitudinally aligned petiole fibres from edible-fruited banana plants, including those belonging to the species Musa acuminata, Musa balbisiana, or to the hybrids Musa paradisiaca and Musa sapientum.

7. The method according to claim 1, wherein the mechanical pre-treatment includes a process that removes sheets of fibres from the outer portion of a pseudostem by virtue of separation between bundles of fibres, about the periphery of the pseudostem, as the pseudostem is rotated.

8. The method according to claim 7, wherein the process for producing sheets includes the steps of feeding a pseudostem into a workstation, supporting the pseudostem for rotation thereof about its longitudinal axis within the workstation, and contacting the rotating pseudostem along substantially its entire length with a fibre-separating device, such that a continuous sheet of fibre is removed from the pseudostem by the fibre-separating device during rotation.

9. The method according to claim 8, wherein fibres of the sheets are subsequently cut generally laterally to a required fibre length to form the fibre furnish.

10. The method according to claim 1, wherein the fibre length distribution of the fibre furnish produced in the mechanical pre-treatment step is such that at least 95% of the fibres have a length less than about 10 mm, is such that at least 95% of the fibres have a length less than about 5 mm, or is such that at least 95% of the fibres have a length less than or equal to about 3 mm.

11. The method according to claim 10, wherein at least 98% of the fibres in the fibre furnish will have substantially the same predetermined fibre lengths.

12. The method according to claim 1 wherein the dewatering occurs in two passes, with the first pass removing greater than about 95% (w/w) of the moisture within the fibre of the fibre furnish.

13. The method according to claim 12, wherein water is returned to the material entering the second pass to assist with removal of residual impurities on the fibres.

14. The method according to claim 12, wherein dewatering occurs in at least one screw press, with each screw press conveying fibre furnish along inside a permeable cylinder, by way of a slowly-rotating screw with a tightening pitch where the separation between flights of the screw progressively decrease, within a perforated cylindrical screen.

15. The method according to claim 12, wherein pressures for the dewatering step are in the range of 0.5 kg/cm² to 2.0 kg/cm².

16. The method according to claim 1, wherein the method includes refining the fibre furnish produced by the mechanical pre-treatment, the refining occurring in a high consistency disc refiner prior to dewatering.

17. The method according to claim 16 wherein the refining of the cellulose fibre cake after the dewatering occurs in one low consistency disc refiner.

18. The method according to claim 16, wherein each disc refiner includes two vertical discs with contoured surfaces, whereby one disc rotates clockwise, while the other disc either remains stationary or rotates counter-clockwise, and wherein with the low consistency disc refiner the cellulose fibre cake is pumped between the discs through an inlet in the centre of one disc, and with the high consistency disc refiner the fibre furnish is pumped between the discs through an inlet in the centre of one disc.

19. The method according to claim 1, wherein the at least one disc refiner for the refining of the cellulose fibre cake is a high consistency disc refiner, followed thereafter by a low consistency disc refiner to produce the mouldable cellulosic fibrous material.

20. The method according to claim 19, wherein each disc refiner includes two vertical discs with contoured surfaces, whereby one disc rotates clockwise, while the other disc either remains stationary or rotates counter-clockwise, and wherein the cellulose fibre cake is pumped between the discs through an inlet in the centre of one disc.

21. Apparatus for producing a mouldable cellulosic fibrous material from a cellulose fibre feedstock, the feedstock having a moisture content greater than about 95% (w/w), the apparatus including:
mechanical pre-treatment apparatus capable of forming a fibre furnish from the feedstock, the fibre furnish having fibres with a fibre length distribution such that at least 95% of the fibres have a length less than about 15 mm;
optionally, a high consistency disc refiner for refining the fibre furnish;
a dewatering press for dewatering the fibre furnish to produce a cellulose fibre cake and a filtrate, the cake having a moisture content less than about 40% (w/w); and
at least one disc refiner to produce the mouldable cellulosic fibrous material from the cellulose fibre cake.

22. Apparatus according to claim 21, wherein the dewatering press includes at least one screw press, with each screw press conveying fibre furnish along inside a permeable cylinder, by way of a slowly-rotating screw with a tightening pitch where the separation between flights of the screw progressively decrease, within a perforated cylindrical screen.

23. Apparatus according to claim 22, wherein the screen perforations are a series of staggered elongate, oval-shaped, openings, each having a mesh configured as a series of diamond-shaped perforations.

24. Apparatus according to claim 23, wherein the mesh is formed from flexibly arranged, interlocked wires, such that the wires can flex during operation, permitting the mesh to extend outwardly to form a generally concave shape during use.

25. Apparatus according to claim 23, wherein the mesh flexes and extends during use with the diamond-shaped gaps expanding from a width of about 1 mm to a width of about 2 to 2.5 mm.

26. Apparatus according to claim 21, wherein the apparatus includes the high consistency disc refiner prior to the dewatering press.

27. Apparatus according to claim 26 wherein the refining of the cellulose fibre cake after the dewatering occurs in one low consistency disc refiner.

28. Apparatus according to claim 26, wherein each disc refiner includes two vertical discs with contoured surfaces, whereby one disc rotates clockwise, while the other disc either remains stationary or rotates counter-clockwise, and wherein for the low consistency disc refiner the cellulose fibre cake is pumped between the discs through an inlet in the centre of one disc, and for the high consistency disc refiner the fibre furnish is pumped between the discs through an inlet in the centre of one disc.

29. Apparatus according to claim 21, wherein the at least one disc refiner for the refining of the cellulose fibre cake is a high consistency disc refiner, followed thereafter by a low consistency disc refiner to produce the mouldable cellulosic fibrous material.

30. Apparatus according to claim 29, wherein each disc refiner includes two vertical discs with contoured surfaces, whereby one disc rotates clockwise, while the other either remains stationary or rotates counter-clockwise, and wherein the cellulose fibre cake is pumped between the discs through an inlet in the centre of one disc.

31. A mouldable cellulosic fibrous material produced by the method of claim 1.

32. A packaging item formed from the mouldable cellulosic fibrous material of claim 31.

33. A filtrate produced by the method of claim 1.

34. A liquid fertiliser produced from the filtrate of claim 33.
